(19) United States
(12) Patent Application Publication
(10) Pub. No.: US 2010/0253963 A1
(43) Pub. Date: Oct. 7, 2010

(54) INFORMATION PROCESSING APPARATUS, PRINTING APPARATUS,JOB PROCESSING METHOD, AND PROGRAM

(75) Inventor: Hiroyuki Amano, Yokohama-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/750,002

(22) Filed: Mar. 30, 2010

(30) Foreign Application Priority Data
Apr. 3, 2009 (JP) 2009-090860

(51) Int. Cl. G06K 15/02

(52) U.S. Cl. 358/1.14

(57) ABSTRACT

When the number of sheets to be used in a job is greater than a limit specified by a user, the user is notified of this fact and is prompted to determine a process associated with the job. When the job is produced, a determination is made as to whether a wasted-printing prevention function is enabled. If the wasted-printing prevention function is enabled, the number of sheets to be used in the produced job is calculated. The calculated number of sheets is compared with the predetermined limit of the number of sheets, and a decision is made as to a process of the job according to a result of the comparison.

### BACKGROUND OF THE INVENTION

1. Field of the Invention

The present invention relates to a printing system configured to transmit a job produced by an information processing apparatus to a printing apparatus.

2. Description of the Related Art

When printing is performed by executing an application installed on an information processing apparatus, it is difficult for many users to know, before the printing is actually performed, what is a correct setting for the application to obtain a desired printed output. To provide convenience to such users, some information processing apparatuses have a preview function that allows users to know, in advance of actual printing using an application, in what manner the printing will be performed (Japanese Patent Laid-Open No. 2006-168061). However, most users do not use the preview function before printing is started, and users generally modify printing conditions depending on an output result of the printing performed actually.

To obtain an intended result, a user has to modify details of printing conditions via a setup dialog box of a printer driver or the like. However, this is troublesome for the user. Besides, it is necessary to again perform a printing operation according to the modified printing conditions, and this leads to wasting resources such as paper, toner, etc. Performing such printing operations many times can affect lifetimes of driving parts of the printing apparatus. In view of the above, many information processing apparatuses provide a preflight checking function that presents information as to current print settings and as to whether the current print settings can be accomplished successfully in an output device such as a printing apparatus to be used.

However, use of the preflight checking function in an ordinary office environment can result in confusion of information and thus a reduction in operation efficiency. It is also known to provide a confirmation function as to the number of sheets to be output. In this function, checking is performed as to whether the number of sheets to be output is greater than the capacity of a finishing device, and outputting is controlled depending on a result of the checking (Japanese Patent Laid-Open No. 2006-168061). However, this technique disclosed in Japanese Patent Laid-Open No. 2006-168061 does not provide a function of preventing wasting of printing due to a difference of an output result from what is intended by a user.

### SUMMARY OF THE INVENTION

According to an aspect of the present invention, there is provided an apparatus configured to output a job to a printing apparatus, comprising a production unit configured to produce the job, a judgment unit configured to judge whether the production unit can determine a number of sheets to be used by the printing apparatus, and a decision unit configured to make a decision as to a process associated with the job based on the calculation made by the production unit in terms of the number of sheets to be output.

Further features of the present invention will become apparent from the following description of exemplary embodiments with reference to the attached drawings.

### BRIEF DESCRIPTION OF THE DRAWINGS

FIG. 1 is a block diagram illustrating a configuration of a printing system.

FIG. 2 is a block diagram illustrating a hardware configuration of a printing system.

FIG. 3 is a diagram illustrating an example of a user interface displayed on a display unit.

FIGS. 4A and 4B are diagrams illustrating examples of user interfaces displayed on a display unit of an operation unit.

FIGS. 5A and 5B are flow charts illustrating a printing process performed in a printing system.

FIG. 6 is a flow chart illustrating a data processing procedure performed by a printing apparatus.

FIG. 7 is a diagram illustrating an example of a user interface displayed on a display unit.

FIG. 8 is a diagram illustrating an example of a user interface displayed on a display unit of an operation unit.

FIGS. 9A and 9B are flow charts illustrating a printing process performed in a printing system.

### DESCRIPTION OF THE EMBODIMENTS

The present invention is described below in further detail with reference to embodiments in conjunction with the accompanying drawings.

### First Embodiment

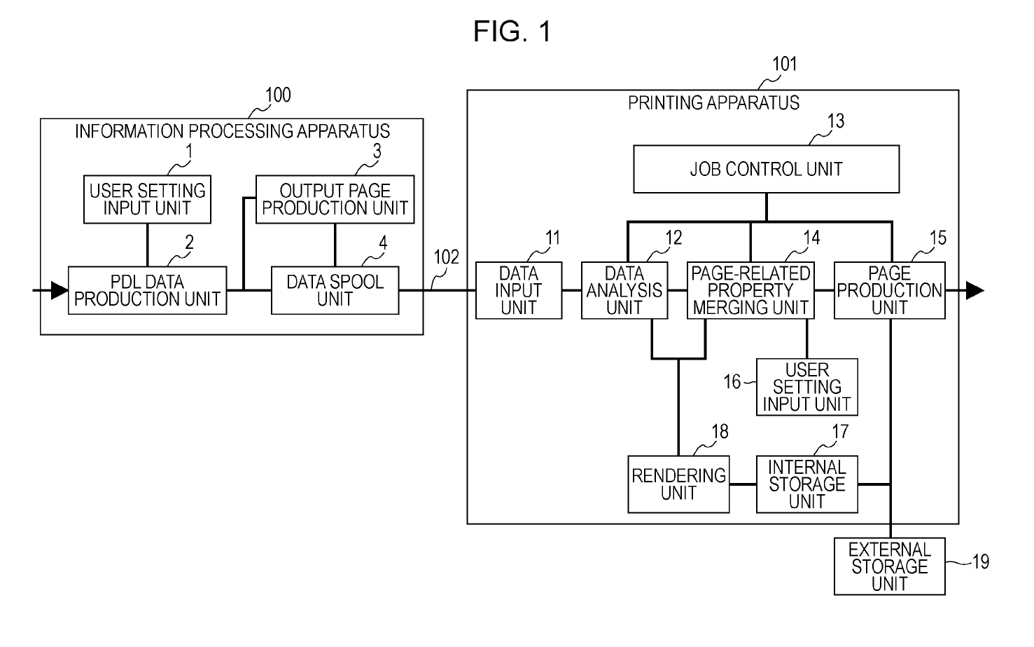

FIG. 1 is a block diagram illustrating a configuration of a printing system including an information processing apparatus and a printing apparatus according to a first embodiment of the invention. In this example, the printing system is configured such that the information processing apparatus 100 and the printing apparatus 101 are capable of communicating with each other via a network 102. The information processing apparatus 100 may be a personal computer configured such that a printer driver is installed therein and thereby allowing it to generate print information and output to the printing apparatus 101 under the control of a specific OS (Operating System). Note that one printer driver is installed in the information processing apparatus 100 for each of printing apparatuses selectable on the network.

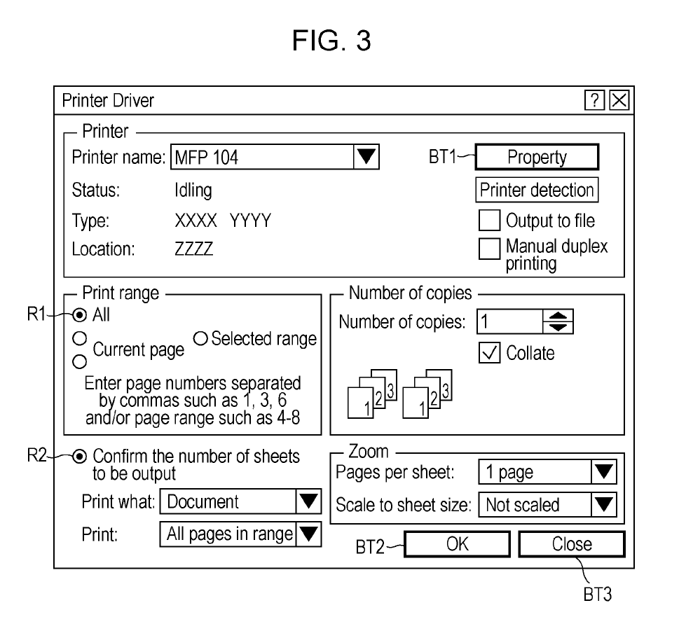

In the information processing apparatus 100 shown in FIG. 1, reference numeral 1 denotes a user-setting input unit configured to accept various settings associated with data to be output from the printing apparatus 101. Note that settings are specified by a user via a print setup dialog box (user interface) that is displayed on a display apparatus by the printer driver installed on the information processing apparatus. The print setup dialog box displayed on the display apparatus is configured to allow a user to input a printer name, a page range to be printed, information necessary for confirmation as to the number of sheets to be output, information specifying a zooming condition, etc. The details thereof will be described later with reference to FIG. 3.

Reference numeral 2 denotes a PDL data production unit configured to convert data into a format (PDL format) interpretable by the printing apparatus to which the data is to be output. Note that PDL stands for Page Description on Language. Reference numeral 3 denotes an output page production unit configured to produce page data in a final output format according to the setting information input via the user-setting input unit 1. For example, in a case where 2UP is specified via the user-setting input unit 1, the output page production unit 3 produces page data taking an output paper size into account such that two pages of image are to be printed on one page. Reference numeral 4 denotes a data spooling unit configured to store produced intermediate data or page data as required. Note that the printing apparatus 101 is one of printing apparatuses usable by the information processing apparatus 100 and specified by the printer driver as a destination apparatus.

In the printing apparatus 101 shown in FIG. 1, reference numeral 11 denotes a data input unit configured to receive data transmitted from the information processing apparatus 100. Reference numeral 13 denotes a job control unit configured to control various modules executed in the printing apparatus 101. The modules controlled by the job control unit 13 include a data analysis unit 12, a page-related property merging unit 14, and a page production unit 15. The data analysis unit 12 is configured to analyze data (PDL data) received from the information processing apparatus 100. Note that in a case where the printing apparatus 101 includes a plurality of data analysis units 12 installed therein, a data analysis unit suitable for the format of the PDL data received from the information processing apparatus 100 is selected and used in operation. Reference numeral 18 denotes a rendering unit configured to render the data, according to the result of analysis performed by the data analysis unit 12, into raster image data that can be processed by an engine unit. More specifically, the processing associated with the raster image is performed by a CPU installed in the printing apparatus 101 such that resultant rendered raster image data is produced on the internal storage unit 17. Reference numeral 16 denotes a user-setting input unit configured to display a panel UI (User Interface) on a display unit disposed on an operation panel thereby allowing a user to input information about various settings associated with outputting by the printing apparatus 101. A specific example of the panel UI will be described later. Property information used by the page production unit 15 in the printing apparatus 101 is determined based on the setting information input via user-setting input unit 16.

According to the attribute information determined by the page-related property merging unit 14, the page production unit 15 produces page data from image information obtained as a result of the rendering. The internal storage unit 17 stores image data produced by the rendering unit 18 or the page data produced by the page production unit 15. Note that the internal storage unit 17 may be realized mainly using a nonvolatile memory medium such as a RAM. Reference numeral 19 denotes an external storage unit configured to store the page data produced by the page production unit 15. The external storage unit 19 may be realized mainly using a high-capacity nonvolatile storage memory medium such as a hard disk. The external storage unit 19 may be installed as a standard or optional device or it may not be provided depending on the functions of the printing apparatus 101 and/or the cost thereof.

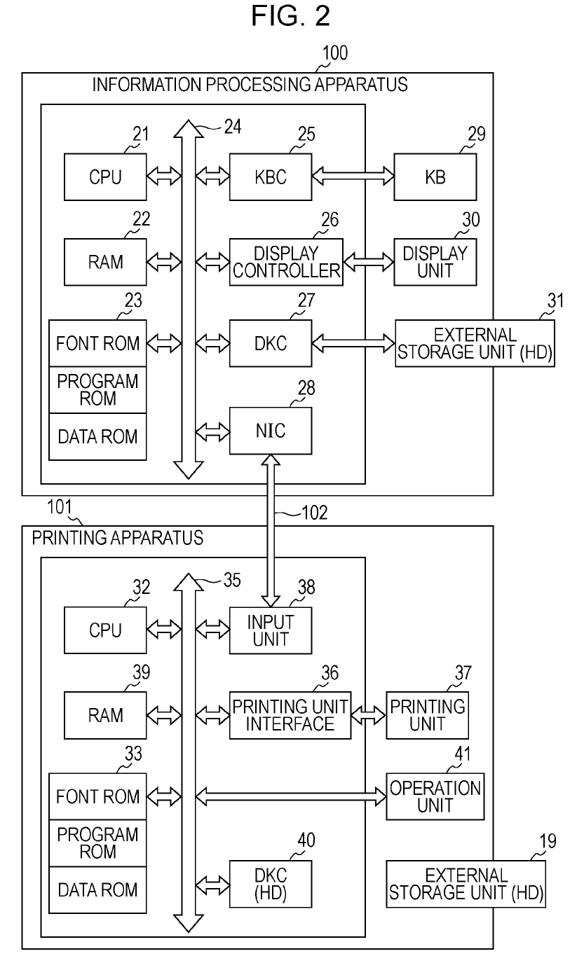

FIG. 2 is a block diagram illustrating a hardware configuration of the printing system shown in FIG. 1. In FIG. 2, reference numeral 21 denotes a CPU that performs various kinds of data processing by loading a program from a ROM 23 or an external memory 31 into a RAM 22 via a system bus 24 and executing the loaded program. The ROM 23 includes a font ROM, a program ROM, and a data ROM. Reference numeral 25 denotes a keyboard controller (KBC) configured to receive key information input via a keyboard (KB) 29. Reference numeral 26 denotes a display controller configured to output a print setup dialog box and dialog information based on an application to a display unit 30. Reference numeral 27 denotes a disk controller (DKC) configured to control accessing to the external memory 31. The external memory 31 may be a flexible disk (FD), a hard disk (HD), or the like. Note that a wasted-printing prevention program and related data are stored in the external memory 31.

Reference numeral 28 denotes a network controller (NIC) that controls communication with the printing apparatus 101 via the network 102. Note that in the present embodiment, there is no particular restriction on a protocol used in communication between the information processing apparatus 100 and the printing apparatus 101. Also note that the modules provided by the printer driver shown in FIG. 1 are loaded in the RAM 22 and executed by the CPU 21 in cooperation with the operating system (OS). In the printing apparatus 101, reference numeral 32 denotes a CPU configured to control a rendering process, a user interface process, and a printing process by executing a control program loaded from a ROM 33 into a RAM 39 via a system bus 35. Reference numeral 38 denotes an input unit configured to acquire the print information transmitted from the information processing apparatus 100. Note that the print information is received in the form of PDL data. Reference numeral 37 denotes a printing unit configured to perform printing according to print data received via a printing unit I/F (interface) 36.

The printing unit 37 is realized using a printer engine based on a laser beam technique or an ink-jet technique. Reference numeral 40 denotes a disk controller (DKC) configured to control writing and reading to and from the external storage unit 19. Reference numeral 41 denotes an operation unit configured to display a UI (User Interface) dialog box described later that allows a user to input a command. The operation unit 41 includes a display unit and a key input unit. The operation unit 41 may be configured in the form of a touch panel.

FIG. 3 illustrates an example of a user interface displayed on the display unit 30 shown in FIG. 2. In this example, the user interface is a print setup dialog box provided by a printer driver installed in the information processing apparatus 100. In FIGS. 3, R1 and R2 denote radio buttons. The radio buttons R1 are buttons used to select a page range to be printed. In the example shown in FIG. 3, “All” is currently selected as the page range to be printed. The radio button R2 is a button that is used to specify a mode in which confirmation is made as to the number of sheets to be output. In the example shown in FIG. 3, “document” is selected as what is to be printed, and “all pages in range” is selected as the range to be printed. If the radio button R2 is selected, a wasted-printing prevention function is enabled. BT1 to BT3 denote buttons. If the button BT1 is selected by a user, a property dialog box is displayed on the display unit 30. Note that the property dialog box is also provided by the printer driver. The button BT2 functions as an OK button. If this button is pressed, the conditions currently selected in the print setup dialog box are applied and printing is started according to the selected conditions. The button BT3 functions as a close button. If this button is pressed, the print setup dialog box is closed. In the present embodiment, when the print setup dialog box is displayed on the display unit 30 by the printer driver, if a user selects the radio button R2, the mode is enabled in which confirming is made as to the number of sheets to be output.

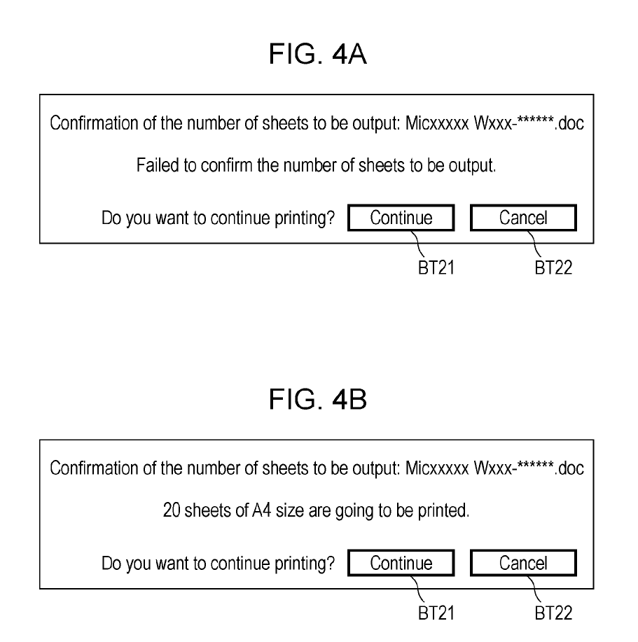

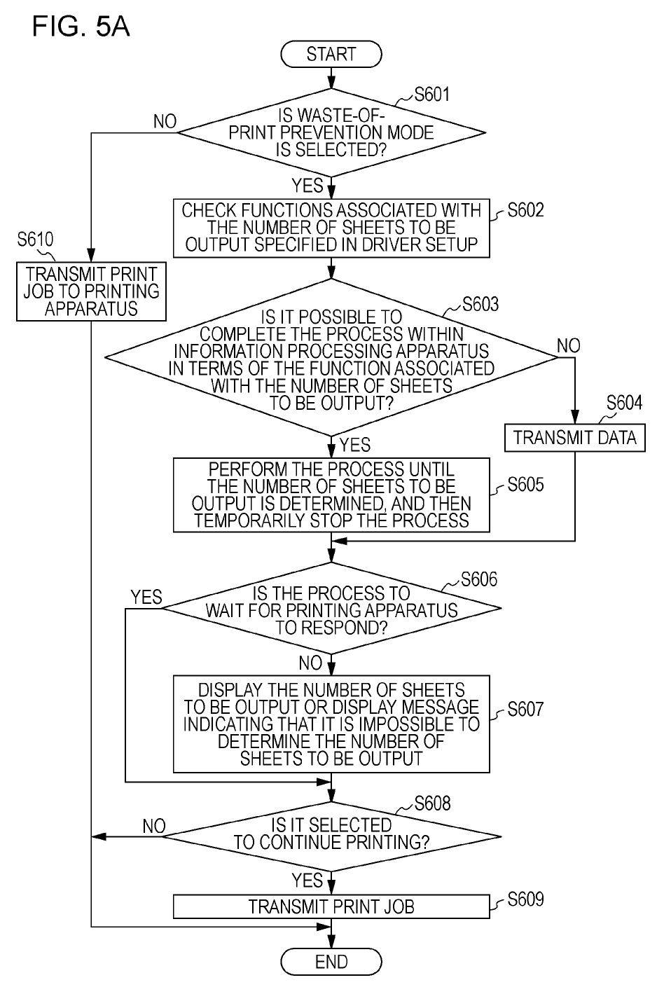

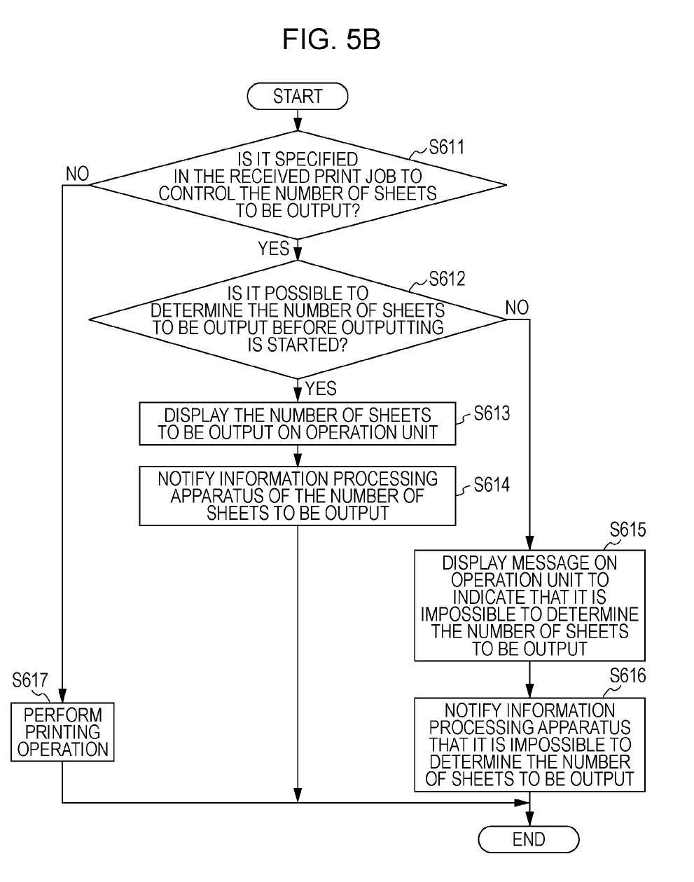

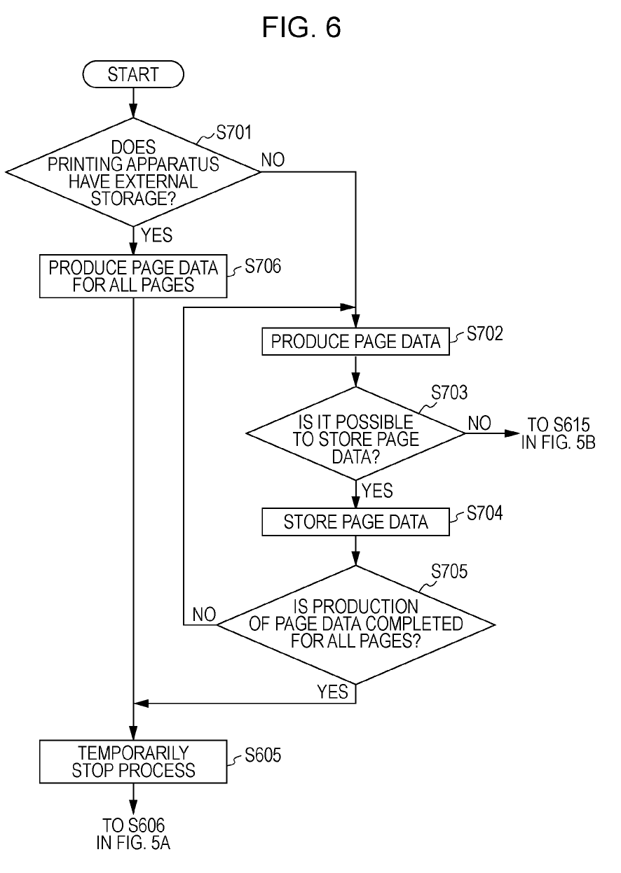

FIGS. 4A and 4B illustrate examples of user interfaces displayed on the display unit of the operation unit 41 of the printing apparatus 101 shown in FIG. 1. The displaying of these user interfaces on the display unit of the operation unit 41 is performed in a process performed by the CPU 32 according to a flow chart described later with reference to FIG. 5A. FIG. 4A illustrates an example of a user interface that is displayed when confirmation is failed as to the number of sheets to be output. FIG. 4B illustrates an example of a user interface that is displayed when confirmation is successful as to the number of sheets to be output.

FIGS. 5A and 5B are flow charts illustrating a printing process performed in a printing system according to the present embodiment. In this example of the printing process shown in FIG. 5, a determination is made as to whether the radio button R2 is selected on the UI screen shown in FIG. 3, and the number of sheets to be output is displayed in a print setup dialog box. In FIG. 5A, S601 to S610 are steps performed by the information processing apparatus 100. These steps are performed by the CPU 21 by loading the printer driver in the RAM 22 and executing it. In FIG. 5B, S611 to S617 are steps performed by the printing apparatus 101. These steps are performed by the CPU 32 of the printing apparatus 101 by loading a control program in the RAM 39 and executing it. An explanation is given below as to a method of processing a job by the printing system including the information processing apparatus and the printing apparatus. The explanation is given for two cases: a first case in which the printer driver that produces a job can determine the number of sheets to be used by the printing apparatus; and a second case in which the printer driver that transmit a job to the printing apparatus cannot determine the number of sheets to be used by the printing apparatus. In the case where the printer driver cannot determine the number of sheets, the job is analyzed by the printing apparatus and the number of sheets to be used is calculated from the number of pages produced for the job. First, in step S601, the CPU 21 determines whether the “wasted-printing prevention function” is enabled by a user by selecting the radio button R2 in the print setup dialog box shown in FIG. 3. In a case where the determination made by the CPU 21 is that the radio button R2 is not selected, the process proceeds to step S610. In step S610, in response to pressing the button BT1, the printer driver transmits, to the printing apparatus 101, PDL data (print job) produced according to image information received from an application. Thereafter, the process is ended. Note that in step S610 described above, when the print job is produced according to settings made by the user, the print job is produced in the mode in which the wasted-printing prevention function is not used.

On the other hand, in a case where the determination made by the CPU 21 in step S601 is that the radio button R2 is selected, the process proceeds to step S602. In step S602, checking is performed as to the function associated with the number of sheets to be output, based on items set on the printer driver. Next, in step S603, from the settings in terms of the functions associated with the number of sheets, the CPU 21 makes a determination as to whether the process can be completed within the information processing apparatus 100 or the process includes a part to be performed by the printing apparatus 101. Depending on the function, the entire process is performed by the information processing apparatus 100, the process is performed in cooperation by both the information processing apparatus 100 and the printing apparatus 101, or the entire process is performed by the printing apparatus 101. In a case where the determination made by the CPU 21 is that the process of the function associated with the number of sheets includes a part performed by the printing apparatus 101, the process proceeds to step S604. In step S604, after completion of the part of the process performed by the information processing apparatus 100, the print job is transmitted to the printing apparatus 101. Thereafter, the process proceeds to step S606.

On the other hand, in a case where the determination made in step S603 by the CPU 21 is that the entire process is performed within the information processing apparatus 100, the process proceeds to step S605. In step S605, the CPU 21 finishes the process performed by the information processing apparatus 100 in terms of the number of sheets to be output, and the CPU 21 temporarily stops the process. Note that in the above step, the CPU 21 calculates the number of sheets to be actually used by the printing apparatus 101 based on the settings associated with printing conditions and the number of pages produced for the job by the printer driver. In step S606, the CPU 21 determines whether a notification as to the configuration information or the status information has been received from the printing apparatus 101. That is, the process waits until the information processing apparatus 100 receives a response to the inquiry issued in S604. In a case where the CPU 21 determines that the configuration information or the status information has been received from the printing apparatus 101, the process proceeds to step S608. In step S608, the CPU 21 displays a user interface dialog box on the display unit 30 to inform the user that the number of sheets to be output cannot be determined and prompt the user to determine whether the printing operation is to be continued. Thereafter, the process is ended. Note that the user interface displayed in step S608 to prompt the user to determine whether the printing operation is to be continued may be similar in content to that displayed on the operation unit 41 (see, FIG. 4A). In this step, the CPU 21 receives a selection command specifying whether the printing operation is to be continued or cancelled, from the user via the UI.

On the other hand, in a case where the determination made by the CPU 21 in step S606 is that the configuration information or the status information is not received from the printing apparatus 101, the process proceeds to step S607. In step S607, the CPU 21 displays a user interface dialog box on the display unit 30 to indicate the determined number of sheets to be output and prompt the user to determine whether the printing operation is to be continued. In step S608, the CPU 21 determines whether a button on the user interface dialog box displayed on the display unit 30 is selected by the user to specify that the printing operation is to be continued. If the determination by the CPU 21 is that the button is selected by the user to specify that the printing operation is to be continued, then the process proceeds to step S609. In step S609, the CPU 21 transmits the print job produced by the printer driver to the printing apparatus 101. Thereafter, the process is ended. Next, referring to the flow chart shown in FIG. 5B, the process performed by the printing apparatus 101 in the printing system is explained. In step S611, the printing apparatus 101 determines whether the settings associated with the print job received from the information processing apparatus 100 include the restriction on the number of sheets to be output. If it is determined that the settings include the restriction on the number of sheets to be output, the process proceeds to step S612. In step S612, the CPU 32 determines whether the number of sheets to be output can be determined before the outputting is started. The process of this determination may be explained in further detail later with reference to FIG. 6.

In a case where the determination made by the CPU 32 is that the number of sheets to be output cannot be determined, the process proceeds to step S615. In step S615, the user interface dialog box shown in FIG. 4A is displayed on the display unit of the operation unit 41 of the printing apparatus 101 to indicate that the number of sheets to be output cannot be determined. In response to the message displayed on the display unit of the operation unit 41 shown in FIG. 4A, the user selects the button BT21 to continue the printing operation or the button BT22 to cancel the printing operation. In a case where the CPU 32 determines that the button BT21 is selected by the user, the CPU 32 starts the process of the received print job. In this process, the printing is performed by the printing unit 37. On the other hand, in a case where the CPU 32 determines that the button BT22 is selected by the user, the received print job is discarded, and the process waits for another print job to be received.

In step S616, information is sent to the information processing apparatus 100 to notify that the number of sheets to be output cannot be determined. Thereafter, the process is ended. In the information processing apparatus 100, if the notification is received in step S606 in FIG. 5A, the process proceeds to step S607 and the message indicating that the number of sheets to be output cannot be determined is displayed on the display unit 30. Note that the information sent to the information processing apparatus 100 in step S616 includes the configuration information and/or the status information associated with the output apparatus (the printing apparatus 101 in the present example). The notification process described above may be performed via communication to the information processing apparatus 100 using a protocol such as SNMP (Simple Network Management Protocol). More specifically, the printing apparatus 101 transmits MIB (Management Information Base) information using the SNMP protocol.

On the other hand, in a case where the CPU 32 determines in step S612 that the number of sheets to be output can be determined before the outputting is started, the process proceeds to step S613. In step S613, the CPU 32 displays the user interface dialog box shown in FIG. 4B on the display unit of the operation unit 41. Next, in step S614, the CPU 32 sends information indicating the determined number of sheets to be output to the information processing apparatus 100. Thereafter, the process in the printing apparatus 101 is ended. In response, in the information processing apparatus 100, step S606 and following steps shown in FIG. 5A are performed. As a result, a user interface dialog box similar to that displayed in step S613 is displayed on the display unit 30 of the information processing apparatus 100. The process thereafter is performed as described above. The notification in step S614 as to the number of sheets to be output is sent in the manner described above.

In step S613 described above, the user may specify whether the print job received by the printing apparatus 101 is to be continued or cancelled by selecting the button BT21 or the button BT22 displayed on the operation unit 41. In step S613, priority may be given to continuing the printing operation. In this case, the printing job may be automatically started. In a case where the CPU 32 determines in step S611 that the settings do not include the restriction on the number of sheets to be output, the printing operation associated with the received print job is performed in step S617, and the process is ended after the printing operation is completed.

FIG. 6 is a flow chart illustrating an example of a data processing procedure performed by the printing apparatus according to the present embodiment of the invention. More specifically, this flow chart illustrates the details of the process in step S612 shown in FIG. 5B as to the determination of the number of sheets to be output. S701 to S705 denote steps of the procedure. These steps are performed by the CPU 32 by loading a control program in the RAM 39 and executing it. First, in step S701, the CPU 32 determines whether the printing apparatus 101 includes an external storage unit. More specifically, the determination is made as to whether the printing apparatus 101 has an external storage unit capable of storing all pages produced for the job received from the information processing apparatus 100. In a case where the CPU 32 determines that the printing apparatus 101 has no such an external storage unit, the process proceeds to step S702. In the case where the printing apparatus 101 has the external storage unit, it is possible to easily store images of all pages. However, if the printing apparatus 101 does not have such an external storage unit, the amount of image data stored in the printing apparatus 101 is limited by the capacity of the RAM 39 installed in the printing apparatus 101. That is, when page data is produced on the RAM 39, all page data cannot necessarily be produced depending on the number of pages specified in the print job and associated page settings.

Thus, in step S702, the CPU 32 starts producing page data associated with the received print job using the RAM 39. In step S703, the remaining capacity of the RAM 39 is checked, and a determination is made as to whether the produced page data can be stored in the RAM 39. In a case where the determination by the CPU 32 is that the produced page data cannot be stored in the RAM 39, the process proceeds to step S615 shown in FIG. 5B. On the other hand, in a case where the determination made in step S703 by the CPU 32 is that the produced page data cannot be stored in the RAM 39, the process proceeds to step S704. In step S704, the CPU 32 stores the produced page data in the RAM 39. Next, in step S705, the CPU 32 determines whether producing of page data is completed for all pages included in the print job. If the determination made by the CPU 32 is that page data has been produced for all pages, the process proceeds to step S605, but otherwise the process returns to step S702.

On the other hand, in a case where the CPU 32 determines in step S701 that the printing apparatus 101 has the external storage unit 19, the process proceeds to step S706. In step S706, the CPU 32 produces all page data and stores the produced page data in the external storage unit 19. The process then proceeds to step S605 and further to step S607. Note that the page data is produced by the CPU 32 by executing modules including the data analysis unit 12, the rendering unit 18, the page-related property merging unit 14, and the page production unit 15. Next, in step S605, the CPU 32 temporarily stops the data processing and advances the processing flow to step S606 shown in FIG. 6.

According to the present embodiment of the invention, in execution of a print job, the result of checking of the number of sheets to be output is displayed individually on both the information processing apparatus and the printing apparatus, and in response to the notification, a user is allowed to input a command to continue or cancel the printing operation. In a case where the user determines that the number of sheets to be output is greater than that intended by the user, the user may change the setting in terms of the page layout, the duplex printing, or the like set in the printer driver so that a decrease is achieved in the number of sheets to be output, thereby preventing the wasted printing.

### Second Embodiment

In the first embodiment, the process described above is performed when the setting is made by a user in the print setup dialog box on the information processing apparatus such that the confirmation is to be made as to the number of sheets to be output. In this case, the user receives a notification as to the number of sheets to be output determined via the process of determining the number of sheets to be output, and the user determines from the notification whether the number of sheets to be output is equal to that intended by the user. Alternatively, in a second embodiment, information indicating the number of sheets to be output may be given to a user for confirmation only when the number of sheets to be output is greater than a limit of the number of sheets specified by the user via the print setup dialog box, as described in detail below.

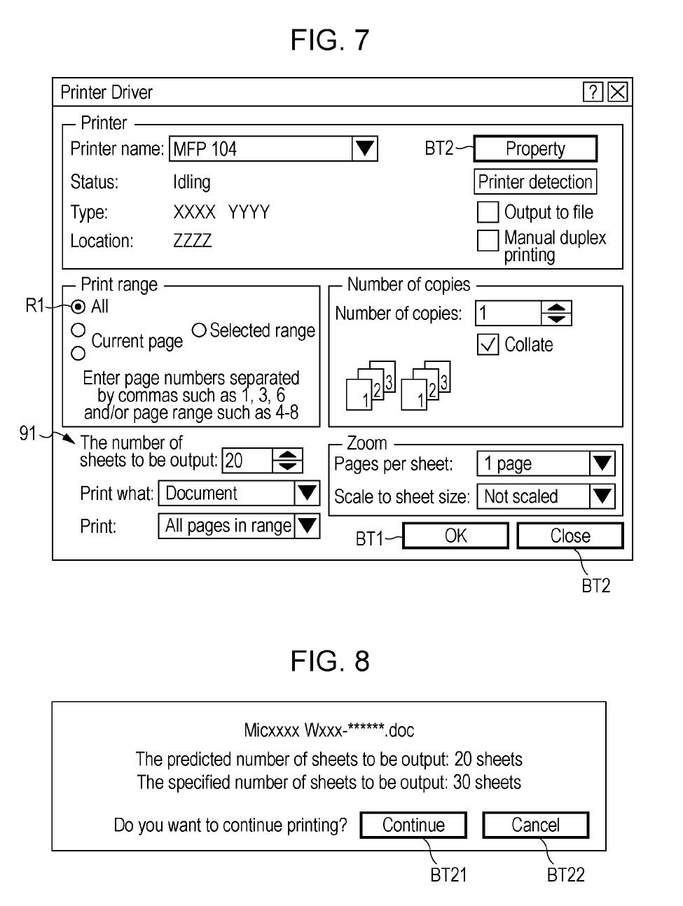

FIG. 7 illustrates an example of a user interface displayed on the display unit 30 shown in FIG. 2. In this example, a print setup dialog box is provided by the printer driver installed in the information processing apparatus 100. In FIG. 7, reference numeral 91 denotes a box in which a user is allowed to specify the limit of the number of sheets to be output. More specifically, when an arbitrary number equal to or greater than 1 is input in this box 91, the input value functions as a threshold value such that if the number of sheets to be output for a print job is greater than the threshold value specified by the user, this fact is notified to the user. When “0” is input in the box 91, the process of checking the number of sheets to be output, which will be described later, is not executed, but printing is performed such that as many sheets as the number of sheets specified by a print job are output. In the following description, by way of example, it is assumed that “20” is specified by a user, before printing is started, as the number of sheets to be output. Note that when “20” is specified by the user as the number of sheets to be output, if the number of pages per sheets is specified as, for example, “2”, the number of sheets may be counted such that the number of output sheets is determined to reach “20” when the number of output pages reaches 40. In the initial print setup dialog box, “0” may be preset in the box 91 as the limit of the number of sheets to be output. In this case, the wasted-printing prevention function based on the specified limit of the number of sheets to be output is not used.

When “20” is specified by the user as the number of sheets to be output, if the duplex printing mode is selected, the number of sheets may be counted such that the number of output sheets is determined to reach “20” when the number of output pages reaches 40. Depending on the combinational condition of the number of pages per sheet and/or the duplex printing mode, the confirmation notification of the number of sheets to be output may not be sent until a user specifies the number of sheets to be output as “20”.

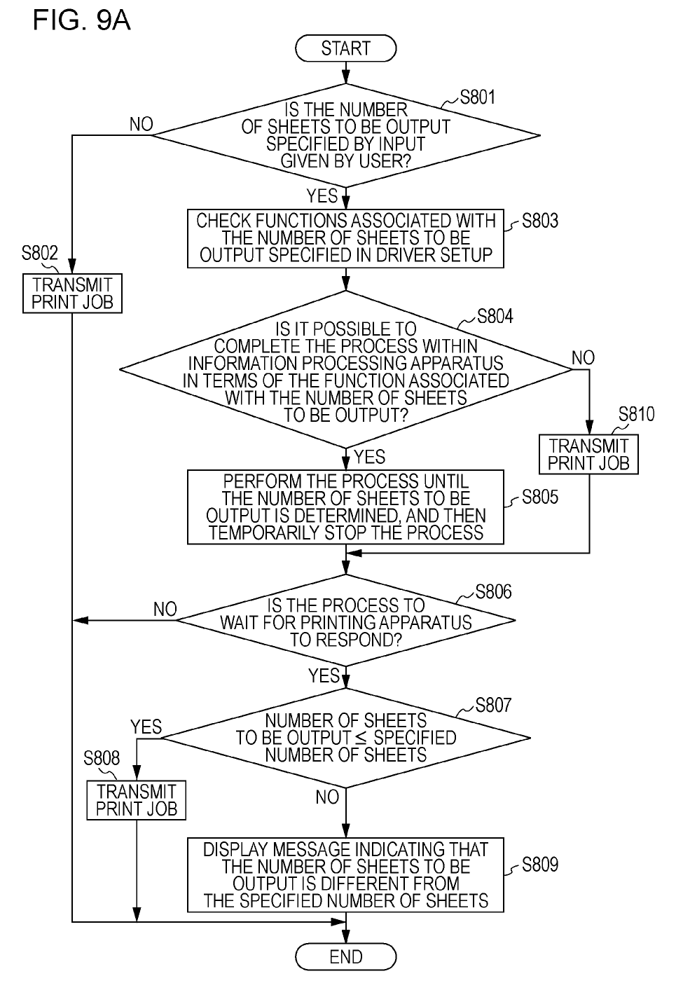

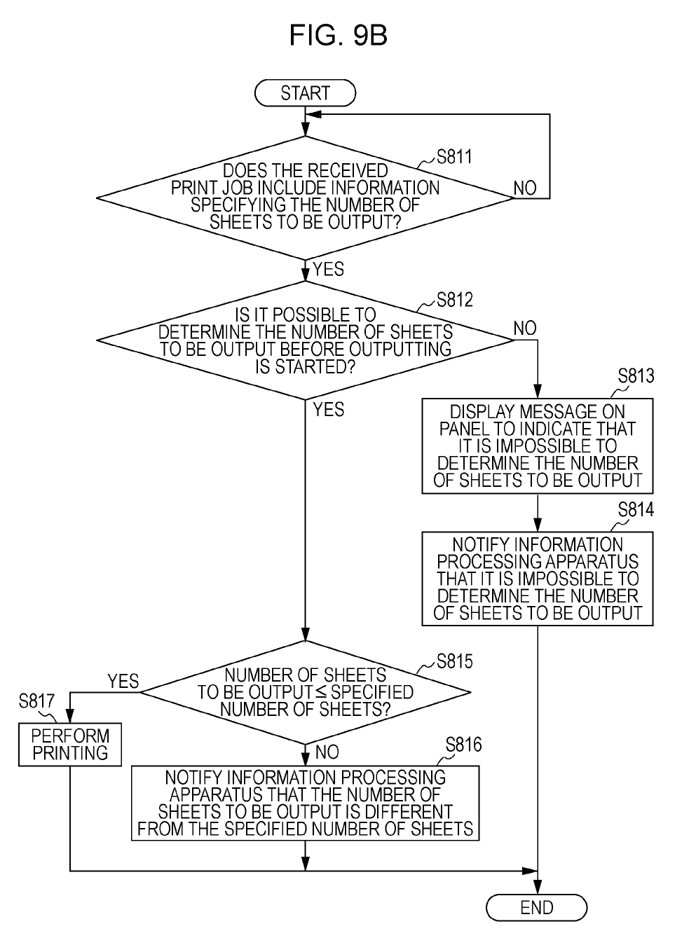

FIG. 8 illustrates an example of a user interface displayed on the display unit of the operation unit 41 of the printing apparatus 101 shown in FIG. 1. The user interface of this example is displayed on the display unit of the operation unit 41 under the control of the CPU 32 in a process described later with reference to a flow chart shown in FIG. 9. Note that the user interface shown in FIG. 8 is displayed to notify that the number of sheets to be output is greater than the user-specified number of sheets to be output. Note that in a case where the number of sheets to be output cannot be determined, a user interface similar to that shown in FIG. 4A is displayed.

FIGS. 9A and 9B are flow charts illustrating a printing process performed in the printing system according to the present embodiment of the invention. In this process, a determination is made as to whether the radio button R2 is selected in the user interface dialog box shown in FIG. 3, and the number of sheets to be output is displayed on a print setup dialog box. In FIG. 9A, S801 to S810 denote steps performed by the information processing apparatus 100. These steps are performed by the CPU 21 by loading a printer driver in the RAM 22 and executing it. In FIG. 9B, S811 to S817 denote steps performed by the printing apparatus 101. These steps are performed by the CPU 32 by loading a control program in the RAM 39 and executing it. First, in step S801, the CPU 21 determines whether a user has specified the number of sheets to be output by inputting a value in the box 91 in the print setup dialog box shown in FIG. 7 to enable the wasted-printing prevention function. In a case where the determination made by the CPU 21 is that no value is input in the box 91 by the user and thus the number of sheets to be output is not specified, the process proceeds to step S802. In step S802, a produced print job is transmitted to the printing apparatus 101. Thereafter, the process is ended. Note that when no value is input, 0″ is set by default in the box 91 shown in FIG. 7 as the number of sheets to be output.

On the other hand, in a case where the CPU 21 determines in step S801 that a value has been input by the user in the box 91 to specify the number of sheets to be output, the process proceeds to step S803. In step S803, the CPU 21 makes checking as to the function associated with the number of sheets to be output, based on items set on the printer driver. Next, in step S804, from the settings in terms of the functions associated with the number of sheets, the CPU 21 makes a determination as to whether the process can be completed within the information processing apparatus 100 or the process includes a part to be performed by the printing apparatus 101. Depending on the function associated with the number of sheets to be output, the entire process is performed by the information processing apparatus 100, the process is performed in cooperation by both the information processing apparatus 100 and the printing apparatus 101, or the entire process is performed by the printing apparatus 101.

In a case where the determination made by the CPU 21 is that the process of the function associated with the number of sheets includes a part performed by the printing apparatus, the process proceeds to step S810. In step S810, after completion of the part of the process performed by the information processing apparatus 100, the print job is transmitted to the printing apparatus 101. On the other hand, in a case where the CPU 21 determines in step S804 that the process of the function associated with the number of sheets is completed within the information processing apparatus 100, the process proceeds to step S805. In step S805, the CPU 21 performs the process, assigned to the information processing apparatus 100, in terms of the number of sheets to be output. After the completion thereof, the CPU 21 temporarily stops the process.

Next, in step S806, the CPU 21 determines whether a notification as to the configuration information and/or the status information of the printing apparatus 101 has been received from the printing apparatus 101. In a case where the CPU 21 determines that the configuration information and/or the status information has been received from the printing apparatus 101, the process proceeds to step S807. In step S807, the CPU 21 compares the value determined by the information processing apparatus 100 or the printing apparatus 101 as to the number of sheets to be output with the user-specified number of sheets to be output. In a case where the CPU 21 determines that the number of sheets determined by the information processing apparatus 100 or the printing apparatus 101 is equal to or smaller than the user-specified number of sheets, the process proceeds to step S808. In step S808, the CPU 21 transmits the print job produced by the printer driver to the printing apparatus 101. Thereafter, the process is ended.

On the other hand, in a case where the CPU 21 determines in step S807 that the number of sheets determined by the information processing apparatus 100 or the printing apparatus 101 is greater than the number of sheets specified by the user, the process proceeds to step S809. In step S809, the CPU 21 displays a message on the screen of the display unit 30 of the information processing apparatus 100 to indicate that the determined number of sheets to be output is different from the specified number of sheets. Thereafter, the process is ended. Note that the content of the message displayed may be similar to that which is displayed on the operation unit 41 of the printing apparatus 101 (see FIG. 8). As in the first embodiment described above, the user determines whether the printing operation is to be continued or canceled by selecting a corresponding button in the displayed dialog box. An arbitrary value of the user-specified number of sheets to be output may be registered as a favorite printer setting in the printer driver. This allows a user to easily control the printing operation by selecting a proper setting for a particular number of sheets to be output.

On the other hand, if the print job is transmitted in step S808 to the printing apparatus 101, the printing apparatus 101 starts the process shown in FIG. 9B. Steps S811 and S812 are similar to steps S611 and S612 shown in FIG. 5B and thus a duplicated explanation thereof is omitted. If the CPU 32 determines in step S812 that the number of sheets to be output can be determined before outputting is started, the process proceeds to step S815. In step S815, the CPU 32 compares the value determined by the printing apparatus 101 in terms of the number of sheets to be output with the user-specified number of sheets to be output. In a case where the CPU 32 determines from the comparison that the determined number of sheets to be output is equal to or smaller than the specified number of sheets, the process proceeds to step S817. In step S817, the CPU 32 outputs print data produced on the RAM 39 to the printing unit 37. Thereafter, the process is ended.

On the other hand, in a case where the CPU 32 determines in step S815 that the value determined by the printing apparatus 101 as to the number of sheets to be output is neither equal to nor smaller than the user-specified number of sheets, the process proceeds to step S816. In step S816, the CPU 32 transmits a message to the information processing apparatus 100 to notify that the number of sheets to be output is greater than the user-specified number of sheets. Thereafter, the process is ended. Note that information indicating the user-specified number of sheets to be output is included in the information of the print job produced by the printer driver. On the other hand, in a case where the CPU 32 determines in step S812 that the number of sheets to be output cannot be determined, steps S813 and S814 are performed in a similar manner to steps S613 and S614 in FIG. 5B, and then the process is ended.

According to the present embodiment, only in the case where the number of sheets to be output is greater than the user-specified number of sheets, the user is prompted to select whether to continue or cancel the print job. In accordance with the selection made by the user, the print job is continued or canceled. That is, when the number of sheets to be output is equal to or smaller than the user-specified number of sheets, no notification is given to the user and the print job with the number of sheets equal to or smaller than the user-specified number is processed in a similar manner to a normal print job.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-090860 filed Apr. 3, 2009, which is hereby incorporated by reference herein in its entirety.

What is claimed is:

1. An apparatus configured to output a job to a printing apparatus, comprising:
a production unit configured to produce the job;
a judgment unit configured to judge whether the production unit can determine a number of sheets to be used by the printing apparatus; and
a decision unit configured to make a decision as to a process associated with the job based on a calculation made by the production unit in terms of the number of sheets to be output.

2. The apparatus according to claim 1, further comprising:
an accepting unit configured to, when the calculated number of sheets is greater than a set limit in terms of the number of sheets, accept a command to continue or cancel the job.

3. The apparatus of claim 2,
wherein the decision is made such that in a case where the accepting unit accepts the command to continue the job, the decision unit decides that the process associated with job is to be continued, while in a case where the accepting unit accepts the command to cancel the job, the decision unit decides that the process associated with job is to be cancelled.

4. The apparatus according to claim 1, further comprising:
an inquiry unit configured to, in a case where a judgment made by the judgment unit is negative, transmit the job to the printing apparatus and inquire whether the number of sheets can be determined.

5. The apparatus according to claim 4,
wherein the decision is made in accordance with a response from the printing apparatus.

6. The apparatus according to claim 4, wherein in a case where the response indicates that the number of sheets is greater than a limit of the set number of sheets, the decision unit makes the decision in accordance with a command to continue or cancel the job.

7. An apparatus comprising:
a judgment unit configured to, when a job is received, judge whether a number of sheets to be used in the job can be determined; and
a notification unit configured to notify an information processing apparatus of a result of a judgment made by the judgment unit.

8. The apparatus according to claim 7, further comprising:
a calculation unit configured to analyze the job and calculate the number of sheets,
wherein in a case in which the judgment unit judges that the apparatus includes an external storage unit capable of storing all pages rendered from the job, the notification unit notifies the information processing apparatus of the calculated number of sheets.

9. The apparatus according to claim 8, further comprising:
a determination unit configured to, in a case in which the printing apparatus does not include the external storage unit, determine whether each page of the job was completely rendered in an internal storage unit,
wherein if each page of the job was completely rendered, the notification unit notifies the information processing apparatus of the calculated number of sheets.

10. A method comprising:
producing the job;
judging whether it is possible, in the producing of the job, to determine a number of sheets to be used by a printing apparatus; and
if the judgment is affirmative, making a decision as to a process associated with the job based on the number of sheets to be used by the printing apparatus calculated in the production of the job.

11. The method according to claim 10, further comprising:
accepting, when the calculated number of sheets is greater than a set limit in terms of the number of sheets, a command to continue or cancel the job.

12. The method according to claim 11,
wherein the decision is made such that in a case where the accepting accepts the command to continue the job, the deciding decides that the process associated with job is to be continued, while in a case where the accepting accepts the command to cancel the job, the deciding decides that the process associated with job is to be cancelled.

13. The method according to claim 10, further comprising:
transmitting, in a case where a judgment is negative, the job to a printing apparatus and inquiring whether the number of sheets can be determined.

14. The method according to claim 13,
wherein the decision is made in accordance with a response from the printing apparatus.

15. The method according to claim 13 further comprising, in a case where the response indicates that the number of sheets is greater than a limit of the set number of sheets, making the decision in accordance with a command to continue or cancel the job.

16. A method comprising:
when a job is received, judging whether the number of sheets to be used in the job can be determined; and
notifying an information processing apparatus of a result of the judgment made in the judging.

17. A computer readable storage medium storing a computer-executable program of instructions for causing a computer to perform the method according to claim 8.

18. The computer readable storage medium according to claim 17, further comprising:
accepting, when the calculated number of sheets is greater than a set limit in terms of the number of sheets, a command to continue or cancel the job.

19. The computer readable storage medium according to claim 17, further comprising:
transmitting, in a case where a judgment is negative, the job to a printing apparatus and inquiring whether the number of sheets can be determined.

20. A computer readable storage medium storing a computer-executable program of instructions for causing a computer to perform the method according to claim 16.
